(19) United States
(12) Patent Application Publication
(10) Pub. No.: US 2014/0075825 A1
(43) Pub. Date: Mar. 20, 2014

(54) BED BUG DETECTION AND CONTROL

(71) Applicants: Kailash C. Vasudeva, Waterloo (CA); Benita Vasudeva, Waterloo (CA); Satnam Singh, Kitchener (CA); Melanie Blass, Waterloo (CA)

(72) Inventors: Kailash C. Vasudeva, Waterloo (CA); Benita Vasudeva, Waterloo (CA); Satnam Singh, Kitchener (CA); Melanie Blass, Waterloo (CA)

(21) Appl. No.: 13/824,983

(22) PCT Filed: Sep. 20, 2011
(86) PCT No.: PCT/CA2011/001052

§ 371 Date: Oct. 9, 2013

Related U.S. Application Data
(60) Provisional application No. 61/384,520, filed on Sep. 20, 2010.
(60) Provisional application No. 61/428,513, filed on Dec. 30, 2010.
(60) Provisional application No. 61/470,229, filed on Mar. 31, 2011.
(60) Provisional application No. 61/483,830, filed on May 9, 2011.

(51) Int. Cl. A01M 1/10; A01M 1/14

(52) U.S. Cl. CPC A01M 1/103; A01M 1/14
USPC 43/114; 43/123

(57) ABSTRACT

A detection and/or control device (1) for bed bugs and other arthropods has at least one surface (9,10) having sufficient texture for a bed bug or other arthropod to climb, leading to a confinement area (6) having surrounding surfaces (7, 8) being sufficiently smooth that the bed bug or other arthropod cannot climb out of the confinement area. The confinement area has a preferably removable and replaceable glue pad or other such trap (16, 26, 66, 85) to trap the bed bug or other arthropod in a specific location within the confinement area. A variety of specific devices are described, including a coaster-type device (1) for placement under bed posts and the like, a frame (21) for light switches and electrical outlets, a cover (80) for heat or air conditioning air outlets, and various extruded rails (50, 52, 60) to act as barriers.

### FIELD OF INVENTION

The invention relates to detection and control or ideally elimination of bed bugs, and potentially other arthropods.

For convenience, reference will be made only to bed bugs, but it should be appreciated that the principles of the invention may be applicable to other arthropods.

### BACKGROUND OF THE INVENTION

It is well known that the problem of bed bug infestations is growing and is gaining increasing public awareness. Better means of detecting bed bugs, and controlling or preferably eliminating them, are badly needed.

Out of concern for the environment and public health, many chemicals that once were highly effective against bed bug infestations, including DDT, are no longer permissible for use in many countries and regions, including the United States and Canada. These chemicals were previously sprayed in homes, office spaces, or other dwellings suspected of bed bug infestation. Many chemicals are still authorized for use, but the resilience of the bed begs and their increasing resistance to such chemicals dictates that additional control means are required.

Bed bug traps exist which take advantage of the well-known fact that bed bugs can readily climb textured surfaces, but cannot climb smooth surfaces. However, there remains a need for devices which detect bed bugs and/or control them more effectively and/or easily than in the past.

### SUMMARY OF THE INVENTION

In view of the above, it is an object of this invention to provide a variety of bed bug detection and/or control means.

In accordance with one aspect of the invention, structures are provided which have a textured surface leading bed bugs into a confinement area, and a smooth surface which then prevents the bed bugs from leaving that confinement area.

In one exemplary embodiment, a coaster-style trap is provided for placement under bed posts or the like.

In a second exemplary embodiment, a frame is provided for installation around light switches and electrical outlets.

In a third exemplary embodiment, a vent cover for heat or air conditioning air registers is provided.

In a fourth exemplary embodiment, various extrusions are provided for installation along walls, above baseboards, in doorways, around platform-type beds, etc..

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is a perspective view of a coaster-type trap;

FIG. 2 is a top view of the coaster-type trap;

FIG. 3 is a perspective view of the drawer of the coaster-type trap;

FIG. 3.1 is a perspective view of the coaster-type trap, sectioned to show the interior;

FIG. 4 is a perspective view, from the rear, of a frame for light switches and electrical outlets;

FIG. 5 is a perspective view of the frame from the front, with the tray of the device open;

FIG. 6 is a perspective view corresponding to FIG. 2, with the tray closed;

FIG. 7 is a perspective view of the top of a heat register cover incorporating a bed bug trap;

FIG. 8 is a top view of the heat register cover;

FIG. 9 is a perspective view of the underside of the heat register cover;

FIG. 10 is a bottom view of the heat register cover;

FIG. 11 is a perspective view of the trapping element used in the heat register cover;

FIG. 12 is a top view of an alternative embodiment of a heat register cover;

FIG. 13 is a side view of the alternative embodiment of a heat register cover;

FIG. 14 is an end view of the alternative embodiment of a heat register cover;

FIGS. 15A-15C show an extruded rail-type trap for a bed base or the like;

FIG. 16 is a perspective view of an alternative embodiment, showing a plastic or metal extrusion of any desired length, suitable for use in doorways, for example;

FIG. 17 is a cross-section of the FIG. 16 embodiment;

FIG. 18 is a perspective view of a clip-in glue trap for the FIG. 16 embodiment; and

FIG. 19 is a perspective view of an end piece for the FIG. 16 embodiment.

### DETAILED DESCRIPTION

Several embodiments of the invention are described below, as specific examples of the invention. These examples include a coaster-style trap intended for placement under bed or furniture posts or the like; a frame for light switches and electrical outlets; heat or air conditioning register covers; and various extrusions for use in doorways, along walls, around platform-style beds, etc..

### Coaster-Style Trap

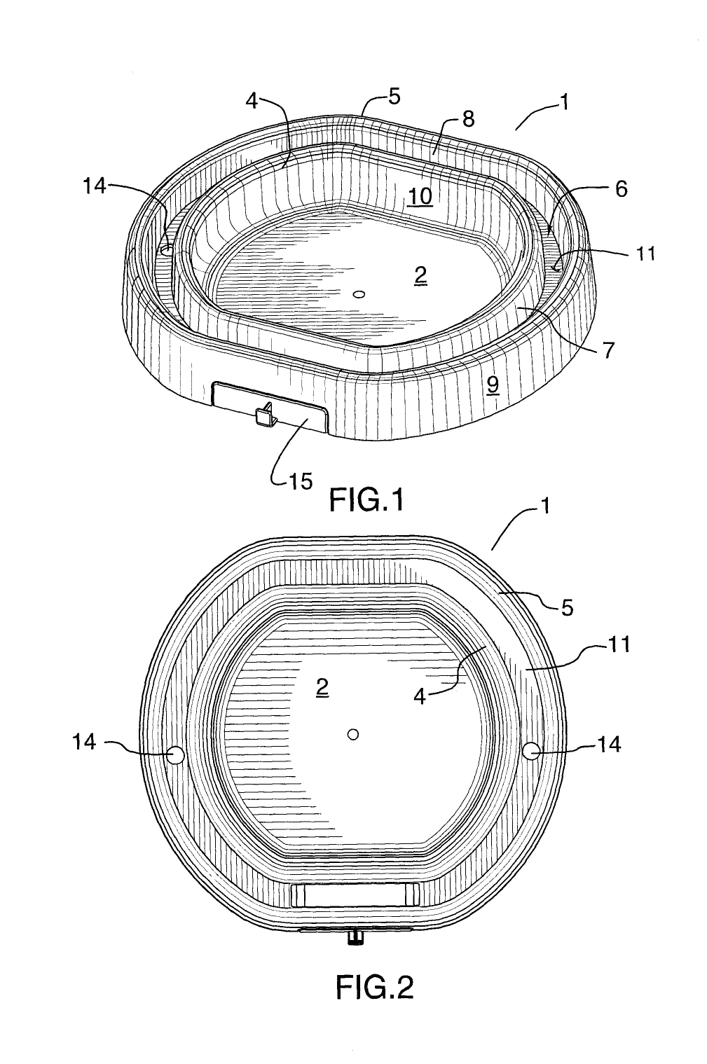

FIGS. 1-3.1 show the coaster-style trap 1 according to the invention. The trap has a flat central area 2 for receiving a bedpost (not shown) or other similar furniture element. Outside the flat central area is an inner wall 4 and an outer wall 5. A space is provided between the inner and outer walls, that space constituting a confinement area 6. The outer surface 7 of the inner wall, and the inner surface 8 of the outer wall, are sufficiently smooth that a bed bug cannot climb them, such that they are trapped in the confinement area 6. To encourage or facilitate bed bugs to enter the trap, preferably both the outer surface 9 of the outer wall, and the inner surface 10 of the inner wall are sufficiently textured that a bed bug can climb them. Thus a bed bug approaching the trap from a surrounding floor area may climb the outer surface 9 in an attempt to get to the bed, and then fall into the confinement area 6 and be unable to escape. Similarly, should a bed bug reach the flat central area 2 by coming down the bedpost, the bed bug may climb the inner surface 10, and then fall into the confinement area 6.

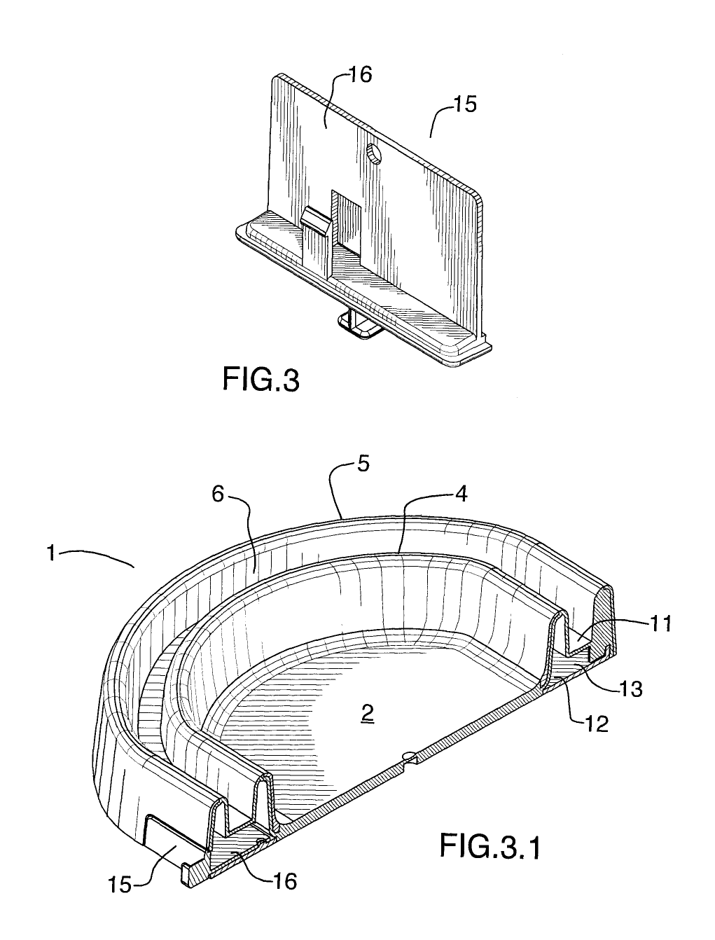

As seen best in FIG. 3.1, the confinement area 6 preferably has an elevated platform surface 11, with the area beneath the platform surface having a lower surface 12 spaced below it and sealed to the trap such that there is a sealed passageway 13 between the platform surface and the lower surface. However, one or more holes 14 through the platform surface are provided (see FIGS. 1 and 2), such that bed bugs in the confinement area may fall through a hole and then find themselves in the sealed passageway.

Preferably, the elevated floor 11 is transparent, so that users can see if any bed bugs have been trapped. The trap therefore also acts as a detection means, not just a trapping device.

Preferably, a removable sliding element 15 is provided, slidable in and out of the afore-mentioned passageway, the passageway being sealed when the sliding element is in position. The sliding element has a flat surface 16, preferably generally aligned with the lower surface of the passageway, and that flat surface preferably carries a glue, tape or other such means as may be established by routine experimentation to be effective in retaining bed bugs. The user may thus, if desired, remove and replace the sliding element 15 from time to time, to dispose of captured bed bugs.

It is expected that any bed bug making its way to the confinement area 6 will eventually migrate to one of the holes 14, and from there will eventually migrate to the sliding element 15 and be retained there.

### Frame for Light Switches and Electrical Outlets

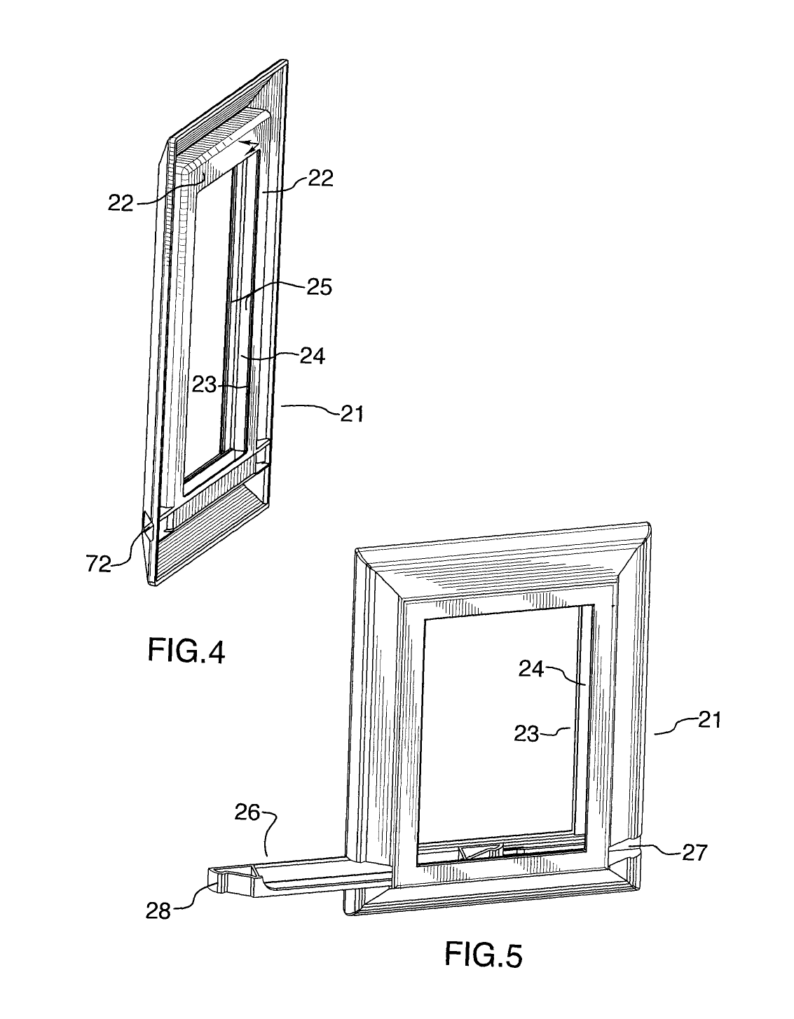

This embodiment is shown in FIGS. 4-6. A frame 21 is provided which can be mounted around conventional light switch and electrical outlet faceplates, to trap bed bugs which otherwise might escape from the walls or electrical boxes through small gaps between the switch housing and the faceplate, or between the faceplate and the wall.

The frame 21 has a flat inner sealing surface 22 intended to rest again the wall and form a seal with the wall so that the bed bugs cannot escape along the wall. Preferably, foam tape or double-sided tape (not shown) is positioned on the sealing surface to ensure that there are no gaps between the sealing surface and the wall.

To install the frame, the conventional faceplate (not shown) is removed from the switch or electrical outlet, and the frame is positioned against the wall. Then the faceplate is screwed back into position, capturing a lip of the inner edge 23 of the sealing surface 22 between it and the wall, further ensuring no gaps.

In front of the sealing surface and around the outside of the installed faceplate is a channel 24. Any bed bug escaping through the switch or outlet and onto the faceplate area will be unable to escape from the channel. The bed bug most likely will fall immediately to the bottom of the channel. If not, the bed bug at least will be unable to escape from the channel, because the inner walls 25 of the channel are made to be too smooth for the bed bug to climb out.

Across the bottom of the channel 24 is a removable tray 26 which defines the bottom of the channel and which slides through openings 27 in opposite lateral edges of the frame, the ends 28 of the tray normally sitting flush with the outside of the frame so as to be as inconspicuous as possible. Also not clearly visible from the drawings is that the tray is U-shaped in cross-section, i.e. generally conforming to the cross-section of the channel and thereby defining a trough. The trough can be loaded with glue or with any other desired treatment, so that the bed bugs are killed and can be removed, most simply by replacing the removable tray.

### Heat or Air Conditioning Register Covers

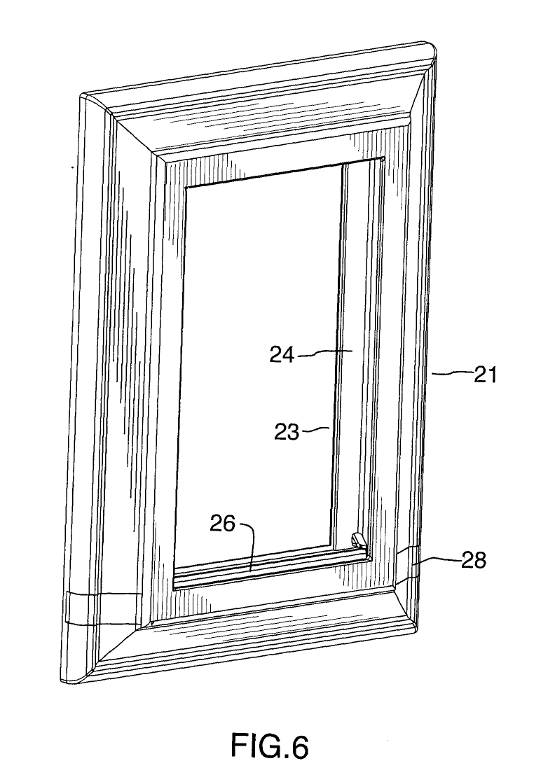

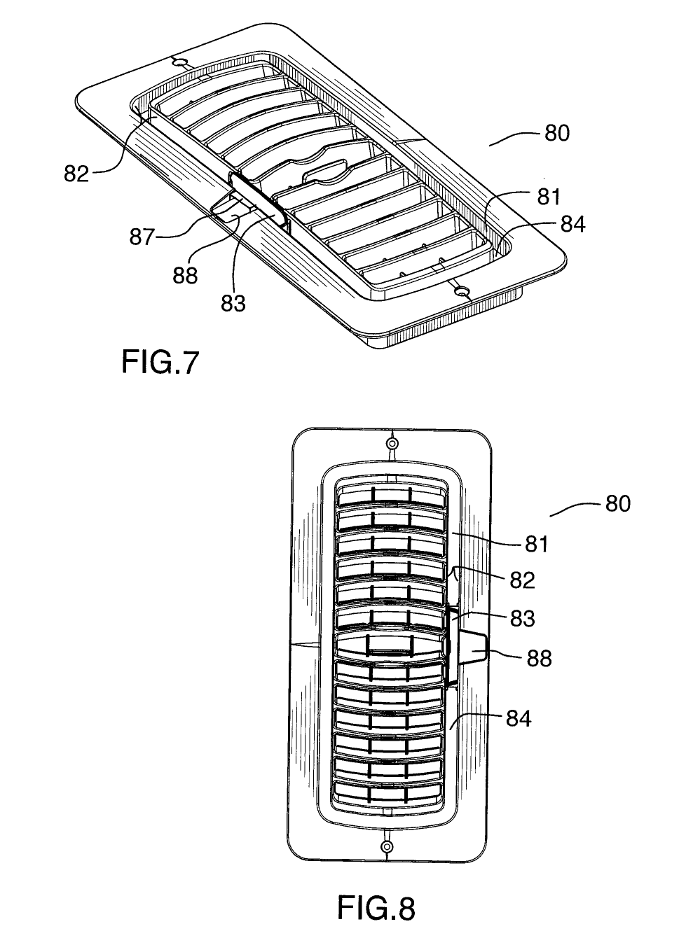

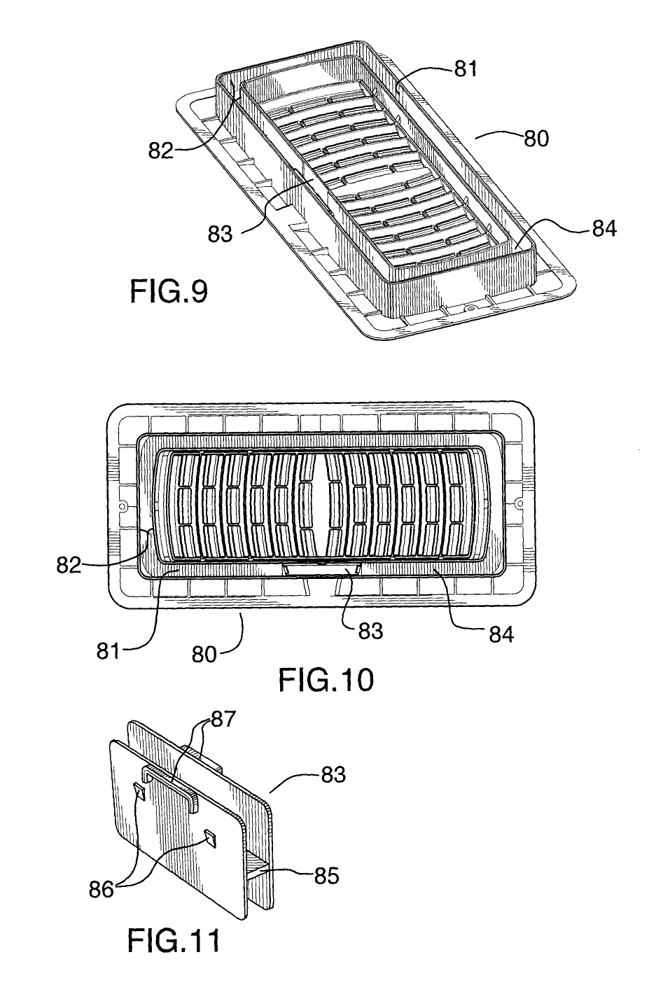

FIGS. 7-11 of the present application show a preferred embodiment of a heat (or air conditioning) floor or ceiling vent cover 80, typically made of plastic, in which both upper and lower surfaces of the cover are provided with a channel 81 into which bed bugs would fall. By virtue of the side walls 82 of the channel being smooth, the bed bugs would only be able to move along the channel, the channel bottom having sufficient texture for them to be able to move. In so moving, they would make their way to a removable, replacable trapping means such as a glue pad piece 83, where they become trapped.

The bottom of the upper channel and the bottom of the channel on the underside are one and the same, i.e. both bottoms are defined by a single web 84. The glue pad piece 83 extends through an opening in the web 84, and has a central crosspiece 85 which aligns with the web and is the same or possibly lesser thickness, so that both channels are continuous, and so that there is a smooth path for the bed bugs from the channel, i.e. so that they do not have to climb from the channel to get to the crosspiece. Each side of the crosspiece 85 constitutes or carries a glue pad or glue layer or the like (not specifically shown), to trap the bed bugs.

The glue pad piece 83, shown in FIG. 11, is essentially H-shaped in cross-section. As mentioned above, its crosspiece 85 aligns with the web 84 when installed. Proper alignment is ensured by catches 86 which engage in notches (not shown) when the piece is installed. The catches preferably are sufficiently secure that a child cannot remove the piece, but not so secure that an adult cannot. Pinching the piece at the top should suffice for removal and replacement. Finger grips 87 are provided at the top to facilitate this, and preferably a depression 88 is provided in the profile of the cover to provide easier access to those finger grips.

If desired, a flexible plastic element (not shown), or some other element can be provided over the trapping means to shield it from view. The function may also be served by or serve as a child-proof cover so that only adults can remove and replace the glue pads.

This embodiment has channels on both sides, and glue pads on each side, so that it can be used either for a floor installation or in a ceiling. However, obviously embodiments could have only upper channels for floor installation, or only channels on the underside for ceiling installation.

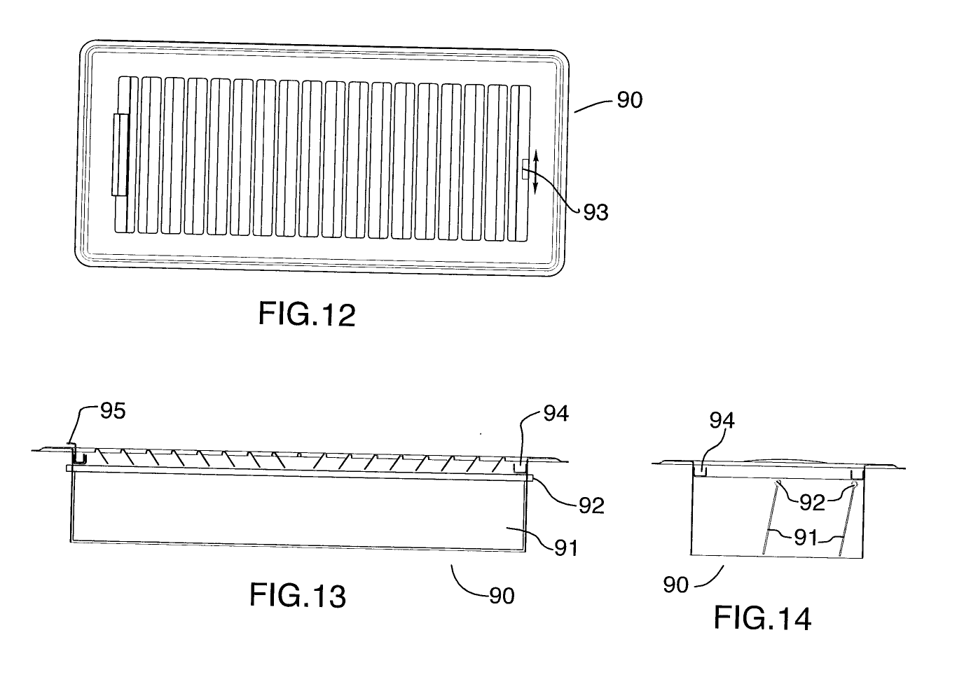

FIGS. 12-14 are top, side and end views of an alternative embodiment similar to conventional metal heat register covers. In this embodiment, the structure could be all metal, or all plastic, or a hybrid. For example, a plastic trap could be added to a conventional type of metal design.

In this embodiment, an otherwise essentially conventional design of heat register cover 90 has moveable vanes 91 on pivots 92, operated by a slider 93, but including bed bug confinement means such as a channel 94 similar to the previous embodiment. Preferably the heat register cover may have more depth than normal to accommodate the bed bug confinement means. As in the previous embodiment, a removable glue trap 95 or similar means may be provided, positioned such that bed bugs in the channel will migrate to it and be trapped.

Another variation applicable where the cover is plastic is for a metal band or several metal elements to be embedded or otherwise installed around the cover near its periphery, so that magnetic cover sheets may be installed if the owner wants to block airflow more completely than possible with just conventional louvers.

### Extruded Rail-Type Traps

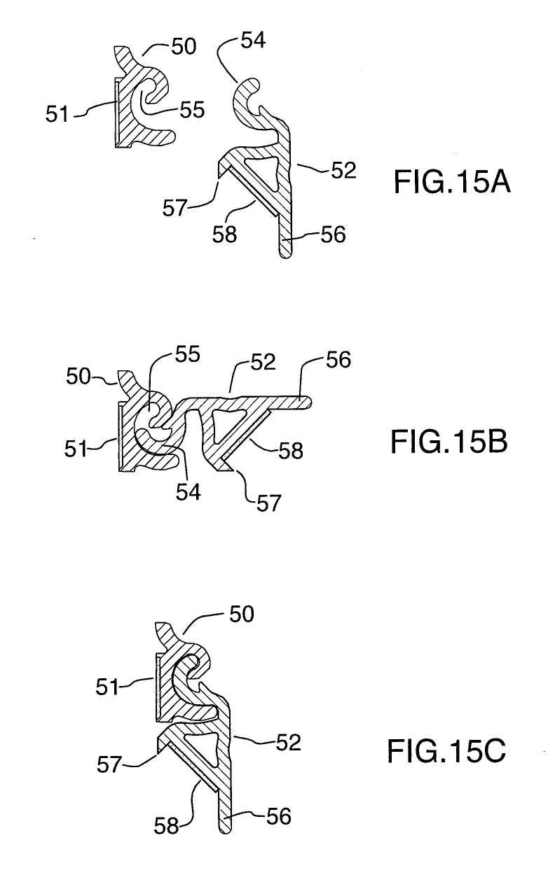

FIGS. 15A-15C show an embodiment which can be adhered around the base of a platform-type bed frame, i.e. where the frame has a vertical panel which contacts the floor, or which can be used in any other analogous situation. A first piece 50, of extruded plastic for example, having an adhesive backing 51 such as double-sided tape or an adhesive foam tape, is adhered to the vertical surface (not shown) of the bed frame or other surface, for example not far above floor level. A second piece 52, also of extruded plastic for example, has a complementary shape such that it engages the first piece but is readily removable therefrom for inspection or replacement. For example, the second piece may have a radiused upward extension 54 which rotates into a correspondingly radiused cavity 55 in the first piece, to an installed position where its lower arm 56 preferably is generally vertical. The lower arm should not be not in contact with the floor, so that a bed bug can crawl under it and cannot climb up the outside, as so that the second piece 52 can be easily installed or removed. Preferably but not necessarily, the lower arm should be close enough to the floor to encourage a bed bug to seek refuge under it, thus increasing the likelihood of heading up the vertical surface. A bed bug climbing up the vertical surface of the bed frame generally cannot get past the upper edge 57 of the second piece, since it should be in contact with the vertical surface, but even if there is a small gap, the bed bug will not be able to get past the first piece. The bed bug thus then reaches a glue strip 58 or other trapping or killing means on the inside of the second piece 52, and is thus trapped or killed. Alternatively, if there is no desire to trap and kill the bed bug in the particular location, the second piece 52 could simply be provided with a smooth surface that the bed bug cannot get around.

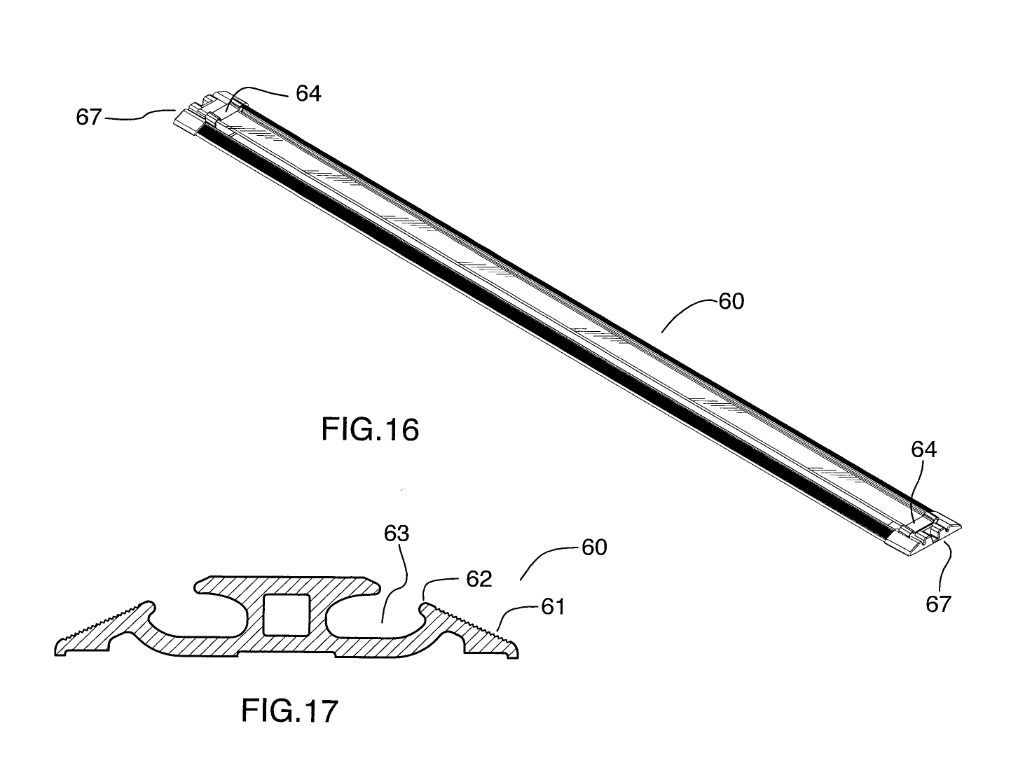

FIG. 16 is a perspective view of an alternative embodiment, showing a plastic or metal extrusion 60 of any desired length, suitable for use in doorways, for example. FIG. 17 is a cross-section of the embodiment.

In this embodiment, the extrusion has textured inclined ramp surfaces 61 climbable by a bed bug, leading to a precipice 62. A bed bug falling off the precipice into the confinement area 63 is unable to escape therefrom, the walls of the confinement area being smooth and sufficiently steep to be unclimbable.

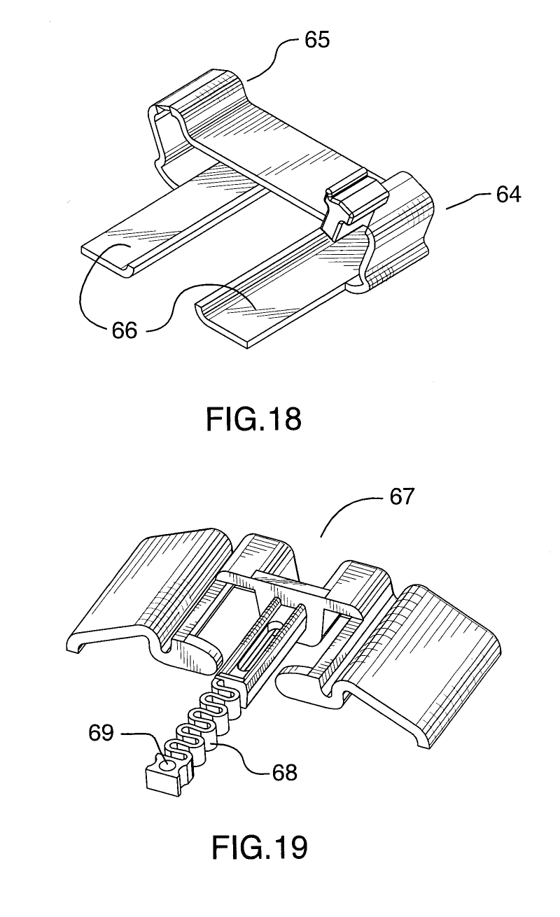

FIG. 18 shows a clip-in glue trap 64 having an upper portion 65 and two flat lower surfaces 66 to receive glue or glue pads to trap the bed bugs in the confinement area. The shape of the glue trap is complementary to the shape of the extrusion 60, and is sufficiently flexible to be readily inserted anywhere desired along the extrusion. FIG. 16 shows a trap 64 at each end of the extrusion, but they could be located anywhere desirable.

FIG. 19 shows an end piece 67 intended for installation at the end of a length of extrusion 60, as shown in FIG. 16. The end piece also complements the shape of the extrusion, and preferably includes the additional feature of a spring 68 which urges the end piece outwardly, for example against the edges of a door frame. A pin or screw or the like (not shown) is installed through the upper surface of the extrusion and through the hole 69 at the end of the spring, for the spring to act against.

In general, these extrusions act as barriers to bed bugs, preventing the movement of bed bugs from one side of the barrier to the other. For example, in one configuration the barrier may have a smooth surface on which bed bugs are unable to grip and thereby unable to traverse, in another configuration they may have a sticky surface which immobilizes the bed bugs, in yet another configuration the barrier may have a combination of such surfaces to trap the bed bugs, possibly including intentionally rough surfaces to encourage bed bug movement in particular directions.

The barrier may be of flexible material such that it can be rolled off a spool, or flexible such that it can be bent horizontally to encircle objects, or it may be of rigid material.

### SUMMARY

The above embodiments all relate to various similar solutions to the bed bug problem. Many variations on the preferred embodiment(s) described above are conceivable within the broad scope of the invention Further variations may be apparent or become apparent to those knowledgeable in the field of the invention.

1. A detection and/)r control device (1) for bed bugs and other arthropods, comprising at least one surface (9, 10) having sufficient texture for a bed bug or other arthropod to climb, leading to a confinement area (6) having surrounding surfaces (7, 8) being sufficiently smooth that the bed bug or other arthropod cannot climb out of said confinement area, characterized in that said confinement area includes a trapping means (15, 16) to trap said bed bug or other arthropod in a specific location within said confinement area.

2. device as in claim 1, comprising a coaster-type device (1) for placement under bed posts and the like, the coaster-type device having both an outer wall (5) and an inner wall (4) around a flat central area (2), a space between said walls constituting a confinement area (6), an outer surface (7) of the inner wall and an inner surface (8) of the outer wall being sufficiently smooth that a bed bug or other arthropod cannot climb them, and an outer surface (9) of the outer wall and an inner surface (10) of the inner wall being sufficiently textured that a bed bug or other arthropod can climb them.

3. A device as in claim 1, further characterized by the confinement area (6) having an elevated platform surface (11), with the area beneath the platform surface having a lower surface (12) spaced below it and sealed to the trap such that there is a sealed passageway (13) between the platform surface and the lower surface, said platform surface having at least one hole (14) therethrough such that bed bugs or other arthropods in the confinement area may fall through a hole and then find themselves in the sealed passageway.

4. A device as in claim 3, further characterized by a removable drawer (15) having a flat surface (16) extending into said sealed passageway, said flat surface capable of carrying glue or a glue strip to trap a bed bug or other arthropod.

5. A device as in claim 1, configured as a frame (21) for installation around light switches and electrical outlets.

6. A device as in claim 1, configured as a cover (80) for heat or air conditioning air outlets.

7. A device as in claim 1, configured as an extruded rail (50, 52, 60).

8. (canceled)

9. (canceled)

10. A device as in claim 1, characterized by said trapping means being removable and replaceable.

11. A device as in claim 2, characterized by said trapping means being removable and replaceable.

12. A device as in claim 5, characterized by said trapping means being removable and replaceable.

13. A device as in claim 6, characterized by said trapping means being removable and replaceable.

14. A device as in claim 7, characterized by said trapping means being removable and replaceable.

15. A device as in claim 1, characterized by the trapping means being a glue pad (16, 26, 66, 85) from which the bed bug or other arthropod cannot escape.

16. A device as in claim 2, characterized by the trapping means being a glue pad (16, 26, 66, 85) from which the bed bug or other arthropod cannot escape.

17. A device as in claim 3, characterized by the trapping means being a glue pad (16, 26, 66, 85) from which the bed bug or other arthropod cannot escape.

18. A device as in claim 5, characterized by the trapping means being a glue pad (16, 26, 66, 85) from which the bed bug or other arthropod cannot escape.

19. A device as in claim 6, characterized by the trapping means being a glue pad (16, 26, 66, 85) from which the bed bug or other arthropod cannot escape.

20. A device as in claim 7, characterized by the trapping means being a glue pad (16, 26, 66, 85) from which the bed bug or other arthropod cannot escape.

21. A device as in claim 10, characterized by the trapping means being a glue pad (16, 26, 66, 85) from which the bed bug or other arthropod cannot escape.
